(19) United States
(12) Patent Application Publication
(10) Pub. No.: US 2011/0251782 A1
(43) Pub. Date: Oct. 13, 2011

(54) Method for Forecasting Vehicle Fuel Economy

(75) Inventors: William Paul Perkins, Dearborn, MI (US); Fazal Urrahman Syed, Canton, MI (US); Derek Hartl, Royal Oak, MI (US); Matthew Fleming, Santa Ana, CA (US)

(73) Assignee: FORD GLOBAL TECHNOLOGIES, LLC, Dearborn, MI (US)

(21) Appl. No.: 12/755,763

(22) Filed: Apr. 7, 2010

(51) Int. Cl. G06F 17/00; G06F 3/048

(52) U.S. Cl. 701/123; 715/771

(57) ABSTRACT

A method for determining and comparing vehicle fuel economy for several different preselected vehicles. The method includes selecting a plurality of vehicles to compare. The user inputs a driving route and a driving style through a user interface into the system. The system utilizes predetermined vehicle fuel economy information along with the driving route and driving style to calculate fuel economy values for each of the selected vehicle models. The system then displays the fuel economy values for each of the selected vehicles to provide a comparison between the selected vehicles over the predetermined driving route using the selected driving style.

### CROSS-REFERENCE TO RELATED APPLICATIONS

Not Applicable.

### FEDERALLY SPONSORED RESEARCH OR DEVELOPMENT

Not Applicable.

### REFERENCE TO A SEQUENCE LISTING

Not Applicable.

### BACKGROUND OF THE INVENTION

1. Field of the Invention

The present invention relates generally to a method for determining and comparing vehicle fuel economy for several different vehicles and more particularly to comparing vehicle fuel economy between selected vehicles for each of the selected vehicles over a predetermined driving route based on a predetermined driving style.

2. Description of the Related Art

United States federal law requires that every new car and light truck sold in the United States have a fuel economy window label. The label sets forth the estimated miles per gallon, or fuel economy data for city and highway driving to provide information and assist consumers compare and shop for vehicles. The fuel economy window label is specific to various powertrain configurations for each vehicle. In addition, the label provides the consumer with an average fuel economy for city driving, an average fuel economy for highway driving and a fuel economy range for each. The fuel economy range takes into account some driving variables including, vehicle speed, driver acceleration, air conditioner use and outside air temperatures. Depending upon the type of driver, the fuel economy may vary outside the fuel economy range. For example, aggressive drivers may get lower fuel economy, while conservative drivers may get higher fuel economy.

In order to determine the specific fuel economy provided on the fuel economy window label, the United States federal government specifies standard city and highway drive testing cycles. Each manufacturer conducts testing according to the drive testing cycles provided by the federal government and provides the Environmental Protection Agency with the results of these tests. This data is publicly available for all tested vehicles. Unfortunately, these tests are not always indicative of a particular consumer's actual driving conditions and styles. Thus, a particular consumer's actual fuel economy may vary significantly from the fuel economy information provided on the window sticker label. Further, while an individual can research current real-world fuel economy for a particular vehicle based on input from current vehicle owners, it is not until they purchase a specific vehicle and drive it that they can determine the actual fuel economy for the specific vehicle based on their specific driving styles or patterns and the particular or specified route.

In addition, fuel economy window labels provide consumers with information and thus an opportunity to make a more informed decision about the ownership cost of purchasing a specific vehicle. Since the fuel economy window label is based on mandated city and highway drive testing cycles, the particular mileage for each vehicle may vary significantly based on the driving route and driver habits. Depending on these variables a first vehicle may obtain a higher fuel economy than indicated on the sticker label, while a second vehicle may obtain lower fuel economy than indicated on the sticker label, leaving the consumer ultimately unable to predict actual fuel economies.

Accordingly, it is desirable to have a method whereby consumers can obtain an estimated fuel economy data for a selected vehicle along a preselected driving route using the driver's style and allow the consumer to compare that fuel economy data for different vehicles over the same preselected driving route. In addition, the estimated fuel economy data takes into account the specific driving styles of the driver. Therefore, customers can better understand the ownership and fuel costs of a vehicle along a preselected driving route.

### BRIEF SUMMARY OF THE INVENTION

A method and system used to compare fuel economy between selected vehicles. The method includes the steps of selecting at least two vehicles to compare. A user inputs a pre-selected driving route through a user interface into the system for creating a route profile. The user inputs modifiers, such as driving style, and the system creates a modified route profile reflecting the effects the input modifiers have on the estimated fuel economy for the vehicle. The system calculates a fuel economy data based on a vehicle model, the route profile or modified route profile and driving style. The system displays a side-by-side comparison of the fuel economy data for each of the selected vehicles over the preselected driving route.

### BRIEF DESCRIPTION OF THE DRAWINGS

FIG. 1 is block diagram of the system;

FIG. 2 is an exemplary embodiment of a first screen of an user interface;

FIG. 3 is an exemplary embodiment of a second screen of the user interface;

FIG. 4 is an exemplary embodiment of a third screen of the user interface;

FIG. 5a is a flow chart for a fuel economy projection system;

FIG. 5b is a flowchart incorporating an additional optional cost model for the fuel economy projection system;

FIG. 6 is a is an example of a preselected driving route and an associated route profile;

FIG. 7 is a graphical representation used to determine the effect of each driving style; and

FIG. 8 is a graphical representation of a modified route profile that incorporates both the preselected driving route and the effect of the selected driving style.

### DETAILED DESCRIPTION OF THE INVENTION

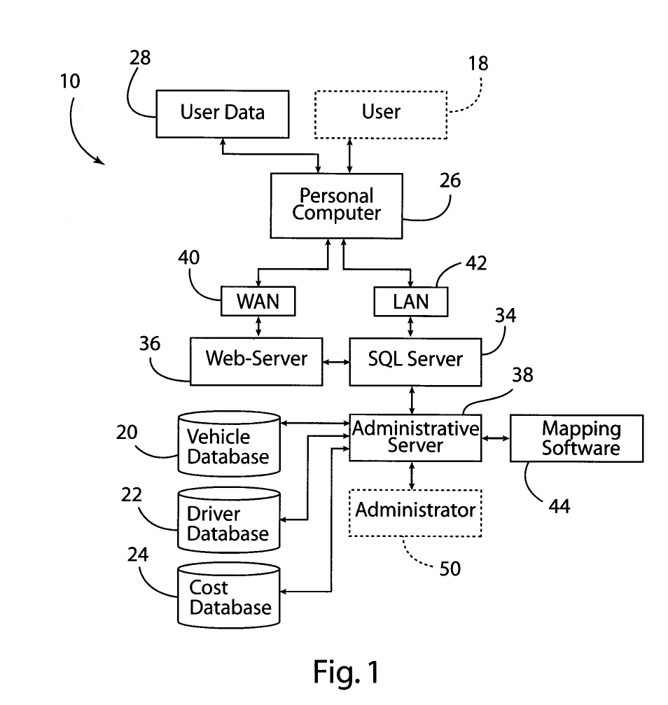

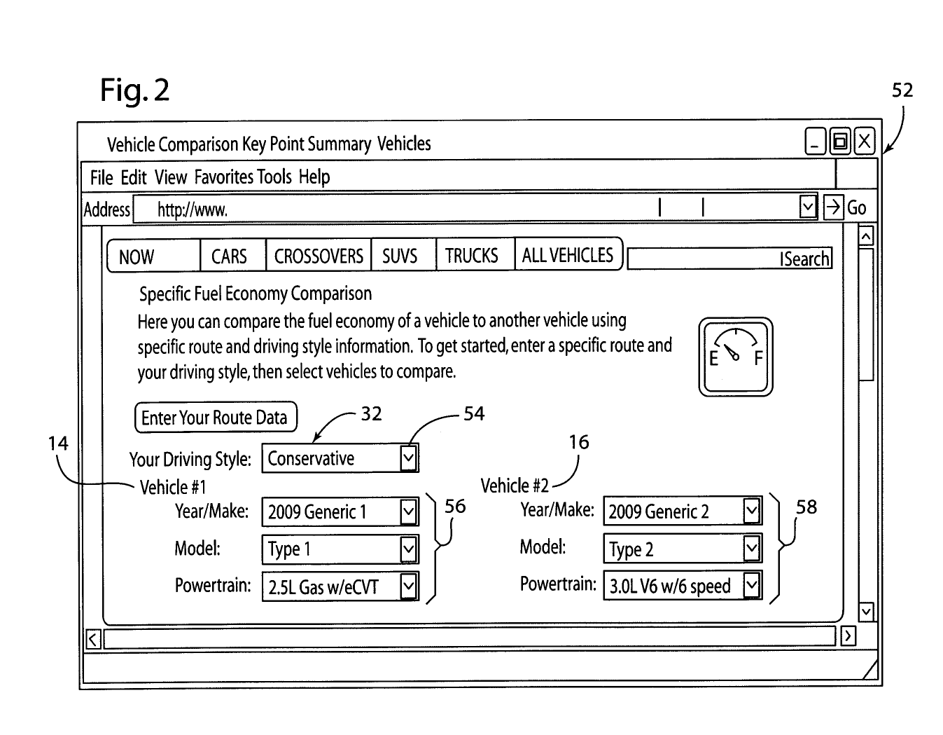

Referring now to the drawings, FIG. 1 illustrates a flow diagram of an overview of a method and system for forecasting vehicle fuel economy, seen generally at 10. The system 10 enables prospective and current users 18 to compare the fuel economy for various preselected vehicles 14, 16 (See FIG. 2) using parameters specified by a user 18. Accordingly, prospective customers can compare the fuel economy of various vehicle brands, models and powertrain configurations to aid in making an informed purchasing decision. It is further understood, that fuel economy and fuel cost, as used herein, includes the energy cost or equivalent calculated economy for hybrid, plug-in hybrid, electric and other contemplated efficiency ratings for various alternative energy vehicles.

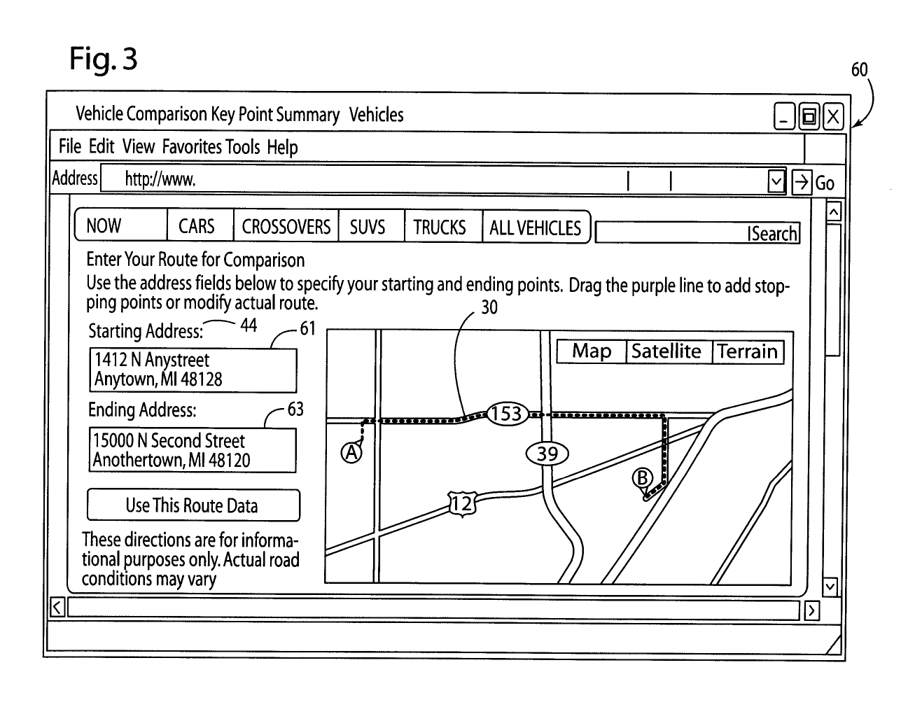

A user 18 inputs user data 28 through user interface 26, for example a personal computer. The user data 28 includes various parameters, for example, a proposed driving route 30 (see FIG. 3) and the user's particular driving styles 32. The user's particular driving style 32 may include information associated with the user's acceleration and braking habits. As shown in the illustrated embodiment, the user 18 inputs the various parameters through the personal computer 26; however, the user 18 may also input the user information and or user data 28 into the system 10 by a kiosk or other user interface, as are known in the art.

The system 10 communicates input from the personal computer 26 to a SQL, structured query language, server 34 via a network 40, 42. Various networks and servers may be utilized to establish communication between the personal computer 26 and the SQL server 34. In one example, the personal computer 26 connects through a wide area network, WAN 40 and communicates through a web server 36 that interfaces with the SQL server 34. In another example, the personal computer 26 communicates through a local access network, LAN 42, directly with the SQL server 34. In addition, a multitude of arrangements exists to provide a user interface for the user 18 to input the needed user data 28 into the SQL server 34 of the system 10, all of which come within the scope of the present invention.

The SQL server 34 communicates the user data 28 to an administrative server 38. The administrative server 38 includes various databases 20, 22, 24 to computationally combine the user data 28 regarding driving style 32, the preselected driving route 30 and the selected first vehicle 14 and second vehicle 16 for comparison. The administrative server 38 includes mapping software 44, vehicle databases 20, driver databases 22 and cost databases 24. The mapping software 44 allows the administrative server 38 to determine a speed and time chart for the preselected driving route 30 input by the user 18. In addition, the mapping software 44 allows the administrative server 38 to determine various environmental variables based on the location of the preselected driving route 30.

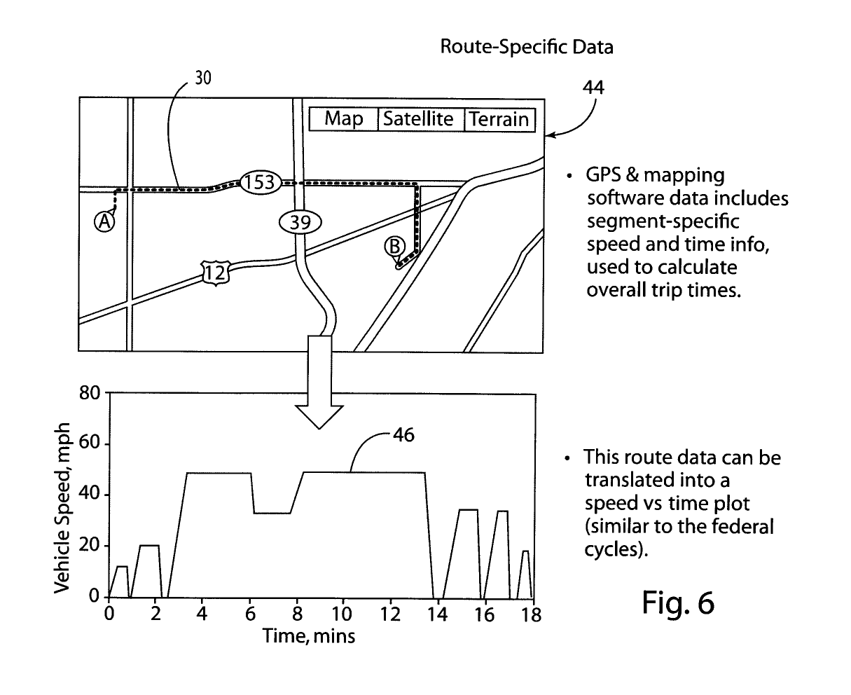

The system 10 determines a route profile 46 (shown in FIG. 6), based on the preselected driving route 30. The route profile 46 is a chart of the vehicle speed, distance traveled and time utilized with the vehicle database 20 to determine the fuel economy 12 for the selected vehicles 14, 16. The mapping software 44 may also include various traffic considerations and variables including traffic flow during the period the user 18 is traveling the preselected driving route 30. Since the mapping software 44 may include general traffic flow pattern data at various times during the day, input by the user of the time of travel coupled with the traffic flow patterns generates additional information which aids in determining the route profile 46. Further additions to the system 10 may include uploading GPS data of actual driving records of the user 18 or data obtained from previous vehicles driven by the user 18, both overall and over the same route. In addition, the mapping software 44 can further contemplate terrain, and various additional environmental and traffic flow variables that may affect the overall fuel economy for the selected vehicles 14, 16. For example, hilly terrain, high traffic volumes, traffic congestion, highway versus city, and stop and go driving conditions.

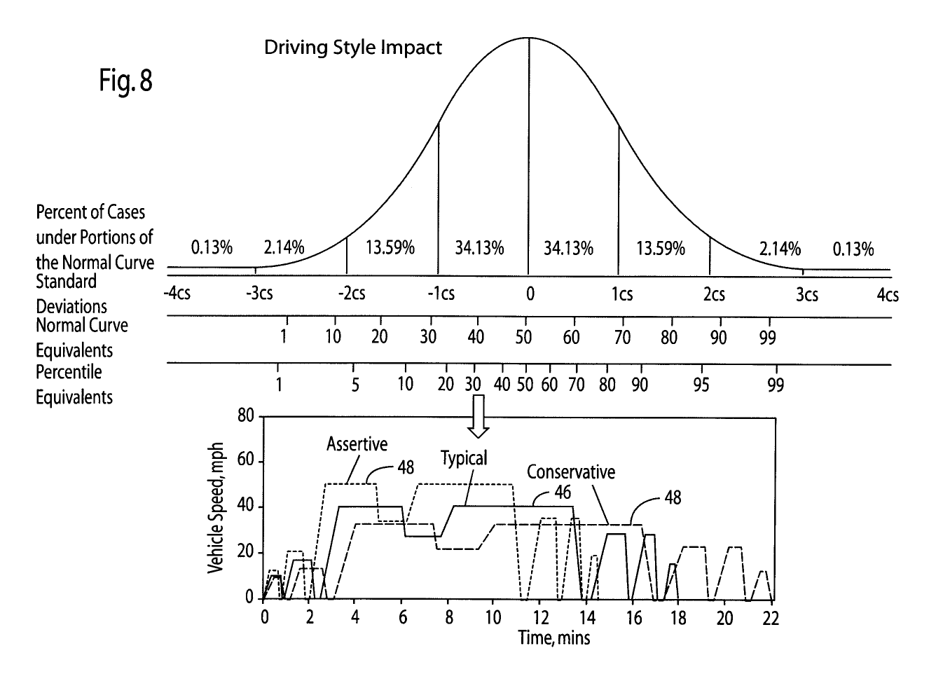

The vehicle databases 20 stored on the administrative server 38 are for each brand, model and powertrain configuration of selected vehicles 14, 16 available for the comparison. The vehicle databases 20 may be based on internal testing of each vehicle or utilize the data reported by a particular manufacturer to the Environmental Protection Agency. The internal testing, as known to one skilled in the art can include various environmental and dynamometer testing to create the vehicle database 20 that incorporates many environmental and vehicle variables for a more accurate determination of the fuel economy 12 over the preselected driving route 30. The driving style 32 is incorporated into the driver database 22 to create a modified route profile 48. The administrative server 38 calculates from the route profile 46 or the modified route profile 48 (shown in FIG. 8) along with the selected vehicle database 20 to determine the fuel economy 12 over the preselected driving route 30.

The system 10 may also include an administrator 50 to maintain and provide updates to the administrative server 38. The administrator 50 would update the databases 20, 22, 24, control and monitor the administrative server 38.

FIG. 2 is an exemplary embodiment of a first screen 52 of the user 18 interface as displayed on the personal computer 26 via the LAN 42 or WAN 40. The first screen 52 allows the user 18 to input the user 18 data. In the illustrated example, the user 18 chooses their driving style 32, shown as conservative, from a driving style pulldown menu 54. The user 18 can select their specific driving style 32 from a list of choices such as, hyper-miler, conservative, moderate, assertive, gas-guzzler. The system 10 on the administrative server 38 includes a driver database 22 that incorporates modifiers for each of the driving style pull down menu 54 selections. The administrative server 38 utilizes these selections to match the user 18 with a driver database 22 to create the modified route profile 48, shown in FIG. 8, and further discussed below. It is also contemplated, the system 10 may be able to determine which driver database 22 best correlates with the user's 18 driving style 32 based on the uploaded driving data from a GPS unit or other driving data gathering device.

In addition, the user 18 also selects the first and second vehicles 14, 16 for comparison. The user 18 selects the first vehicle 14 through a first series of vehicle pull down menus 56. The first series of vehicle pull down menus 56 includes a choice for the year, make, model and powertrain configuration for the first vehicle 14. The selection of the first vehicle 14 is stored in the system 10 and used to determine the vehicle database 20 utilized by the administrative server 38 to calculate the fuel economy 12 for the first vehicle 14. Next, the user 18 selects the second vehicle 16 through a second series of vehicle pull down menus 58. The second series of vehicle pull down menus 58 include choices for the year, make, model and powertrain configuration for the second vehicle 16. The selection of the second vehicle 16 is stored in the system 10 and used to determine the vehicle model 20 utilized by the administrative server 38 to calculate the fuel economy 12 for the second vehicle 16. Further, the user 18 can also enter his specific driving route by selecting the “Enter Your Route Data” button, which leads to the screen shown in FIG. 3.

FIG. 3 illustrates an exemplary embodiment of a second screen 60 through which the user 18 inputs the preselected driving route 30. There are various input methods for the user 18 to select or input into the system 10 the preselected driving route 30. In the illustrated example, the second screen 60 allows the user 18 to input a starting address 61 and an ending address 63 and the system 10 through the mapping software 44 illustrates the preselected driving route 30. It is also contemplated, the system 10 may allow the user 18 to input a driving route 30 from a GPS unit, selecting various points on a map or utilizing some pre-determined route similar to the user's 18 preselected driving route 30. The system 10 may obtain various geographical variables, such as environment temperature, terrain and elevation data of the preselected driving route 30. The geographical variables allow the system 10 and the administrative server 38 to determine or calculate the fuel economy 12 for the selected vehicles 14, 16 based on the user data 28, driving style 32 and the preselected driving route 30. It is further contemplated, that the mapping software 44 can incorporate various other driving variables such as time of travel, traffic flow, and numerous other route specific variables that may affect the fuel economy of the selected vehicles 14, 16. In addition, the mapping software 44 may incorporate all or some of these variables into the route profile 46, as Illustrated in FIG. 6. In the illustrated embodiment, the user 18 inputs the starting address 61 and the ending address 63. The mapping software 44 determines the preselected driving route 30 and displays the driving route 30 on a map for the user 18 on the user interface.

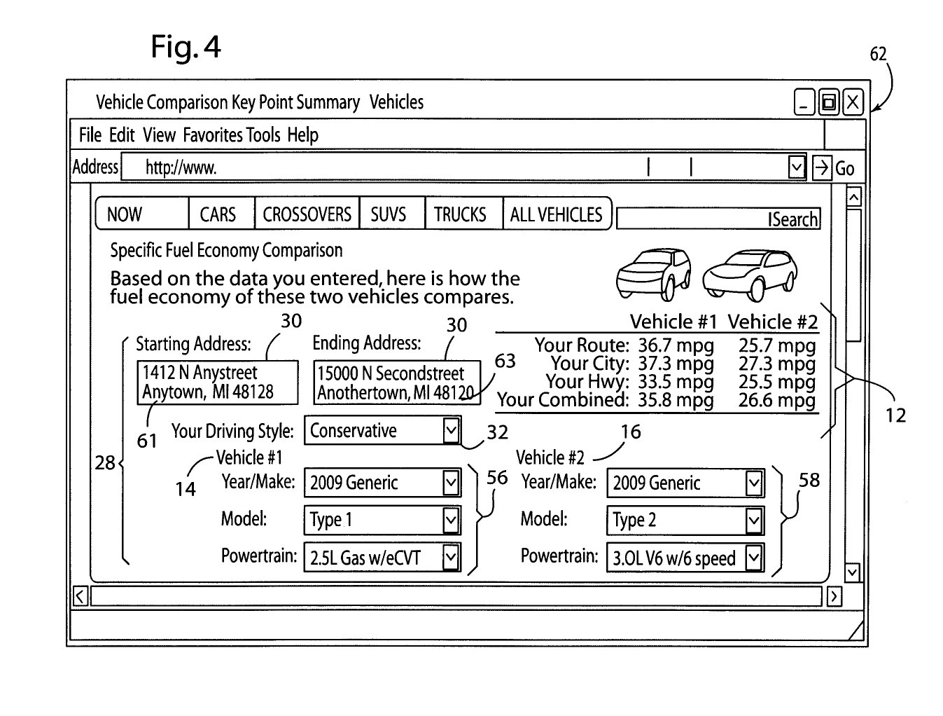

FIG. 4 illustrates an exemplary embodiment of a third screen 62. The third screen 62 is a summary screen showing a comparison between the first and second vehicles 14, 16. The summary screen displays the user data 28, the preselected driving route 30, the first series and the second series of vehicle pull down menus 56, 58 as selected by the user 18 along with the driving style 32. The user 18 can modify the user data 28 and rerun the comparison between different vehicles or by changing any of the user data 28, i.e., preselected driving route 30, driving style 32 or the selected vehicles 14, 16.

The system 10 combines the various inputs from the user 18 to calculate the fuel economy 12 combining the driver database 22, vehicle database 20 and mapping software 44. The system 10 enables the user 18, as a potential consumer, to be informed regarding the operating and fuel cost of the selected vehicles 14, 16 over a preselected driving route 30. Such a system 10 provides the consumer with additional information beyond the generic EPA fuel economy ratings since the EPA fuel ratings do not incorporate driver styles, the driving route, geographical and other vehicle specific variables. The EPA standardized testing is combined with internal testing for specific vehicles 14, 16 to create vehicle databases 20, driver databases 22, route specific variables which are then applied over the preselected driving route 30, to provide the user 18 with a fuel economy 12 for comparison between the first and second vehicles 14, 16.

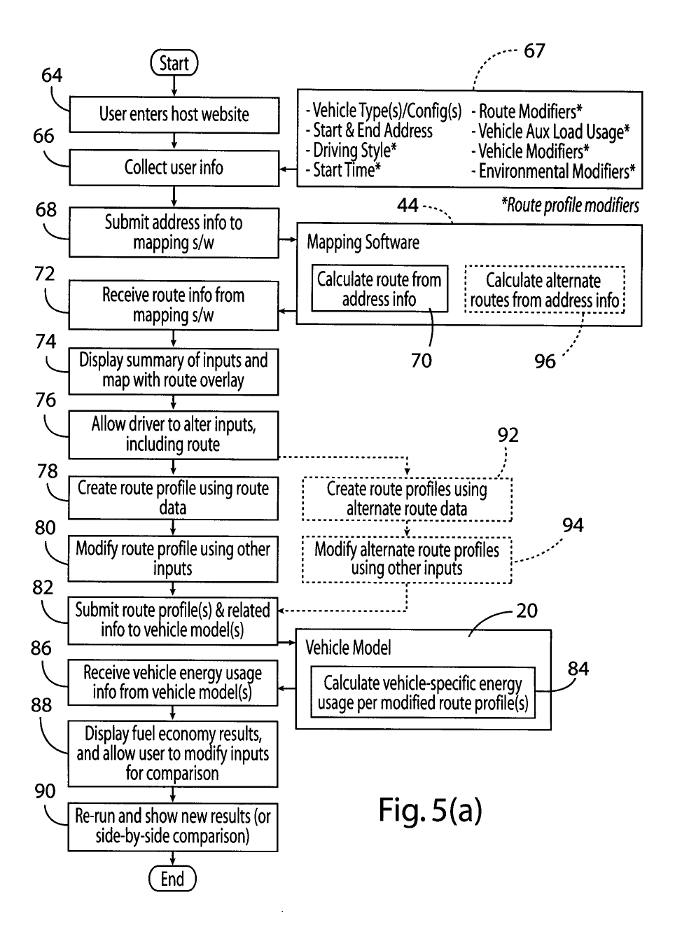

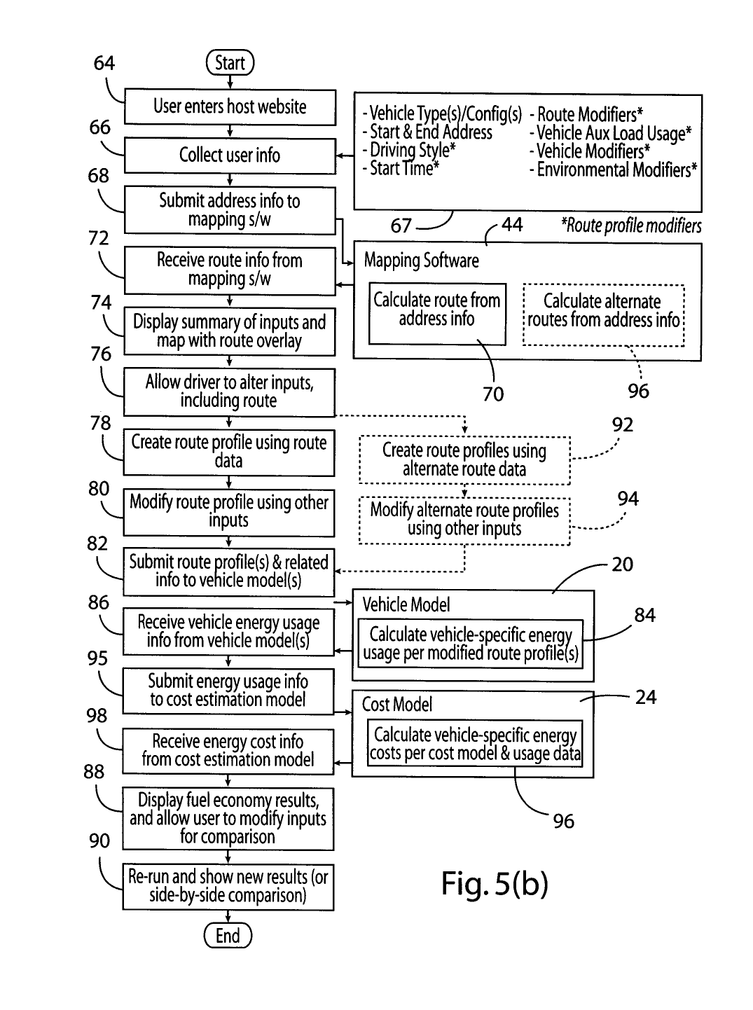

FIG. 5a illustrates a flow chart for the exemplary embodiment of the forecasting vehicle fuel economy system 10 providing a comparison between two vehicles 14, 16 with a fuel economy over the preselected driving route 30. A user 18, via the personal computer 26 or kiosk, enters the host website address, block 64. Through a series of screens 52, 60, 62, such as those described above, the system 10 collects the user data 28, as illustrated at block 66. The user data 28 includes vehicle type and powertrain configuration, starting and ending addresses, driving style, start time, route modifiers, such as the vehicle auxiliary load usage, additional vehicle modifiers and environmental modifiers, block 67. The user data 28 is communicated to the mapping software 44, block 68. The mapping software 44 calculates a route profile 46, as illustrated in block 70, and communicates the route profile 46 back to the system 10, block 72. The system 10 displays a summary of the user data 28, as illustrated in block 74. The system 10 allows the user 18 to alter or modify the user data 28 and rerun the computations resulting from the modification or changes, as illustrated in block 76, allowing the user 18 to input multiple variations of the preselected driving route 30 and different comparisons of several vehicles 14, 16. The system 10 creates a route profile 46 from the user data 28, as shown in block 78. The system 10 based on the user data 28 or route specific variables calculates a modified route profile 48, as illustrated in block 80. The system 10 submits the route profile 46 and the modified route profile 48 into the vehicle database 20, shown in block 82. The vehicle database 20 incorporates the route profile 46 and modified route profile 48 to compute the fuel economy 12 for each of the selected vehicles 14, 16 driving the preselected driving route 30, as shown in block 84. The vehicle database 20 sends the calculated energy usage, or fuel economy 12, back to the system 10, as illustrated in block 86. The system 10 displays the results on the user interface or the user's personal computer 26 for a side-by-side comparison of the fuel economy 12 of several vehicles 14, 16, as illustrated in block 88. The user 18 can rerun the simulation modifying various user data 28, such as the selected vehicles 14, 16, the driver style 32, and preselected driving route 30, as illustrated by block 90.

The system 10 enables the user 18 to modify and create alternate routes as shown in block 92. The alternate route or additional modifications to the user data 28 is then used to again create an alternate route profiles 48, as shown in block 94. The alternate route and modification to the preselected driving route 30 is communicated to the mapping software, as shown in block 96, and the system 10 reruns the calculations to display the fuel economy 12 for the selected vehicles 14, 16. The system 10 utilizing the alternate route profile 48 or changes to the user data 28 by the user 18. The system 10 would determine the alternate route profile 48 in a similar manner as previously discussed for the route profile 46.

FIG. 5b illustrates the optional cost database 24. The system 10 submits the energy usage to the cost database 24 as shown in block 95. The cost database 24 includes regional specific information to determine the actual cost for the selected vehicles 14, 16 driving the preselected driving route 30, as shown in block 96. The cost database 24 would further add geographical fuel costs, additional environmental variables and numerous regional variables could be included that are associated with the preselected driving route 30 inputted by the user 18 to determine the cost estimation for each of the selected vehicles 14,16. The cost database 24 communicates the cost estimation back to the system 10, as shown in block 98, allowing the system 10 to display a side-by-side comparison of several selected vehicles 14, 16 the fuel economy 12 and cost estimation to the user 18.

As illustrated in FIG. 6, the system 10 determines the route profile 46, based on the preselected driving route 30, input by the user 18. The route profile 46 is a chart depicting the vehicle speed versus the time over the preselected driving route 30. The mapping software 44 for the preselected driving route 30 creates the route profile 46. The route profile 46 is communicated to the system 10 and utilized with the vehicle database 20 to determine fuel economy 12 for the selected vehicles 14, 16. The mapping software 44 may also include various traffic considerations and variables including traffic flow, when the user data 28 includes the times of the day the user 18 travels the preselected driving route 30. An additional aspect may include uploading GPS data related to the preselected driving route 30 by the user 18 into the system 10. In addition, the mapping software 44 can further contemplate terrain, various additional environmental variables and traffic considerations such as traffic flow that may affect the fuel economy 12 for the selected vehicles 14, 16. For example, hilly terrain, high traffic volumes, traffic congestion, highway versus city, and stop and go driving conditions may be incorporated by the system 10 into the route profile 46 or the modified route profile 48. As previously discussed, it is also contemplated from the uploaded GPS data that the system 10 may determine the driving style 32 for the user 18.

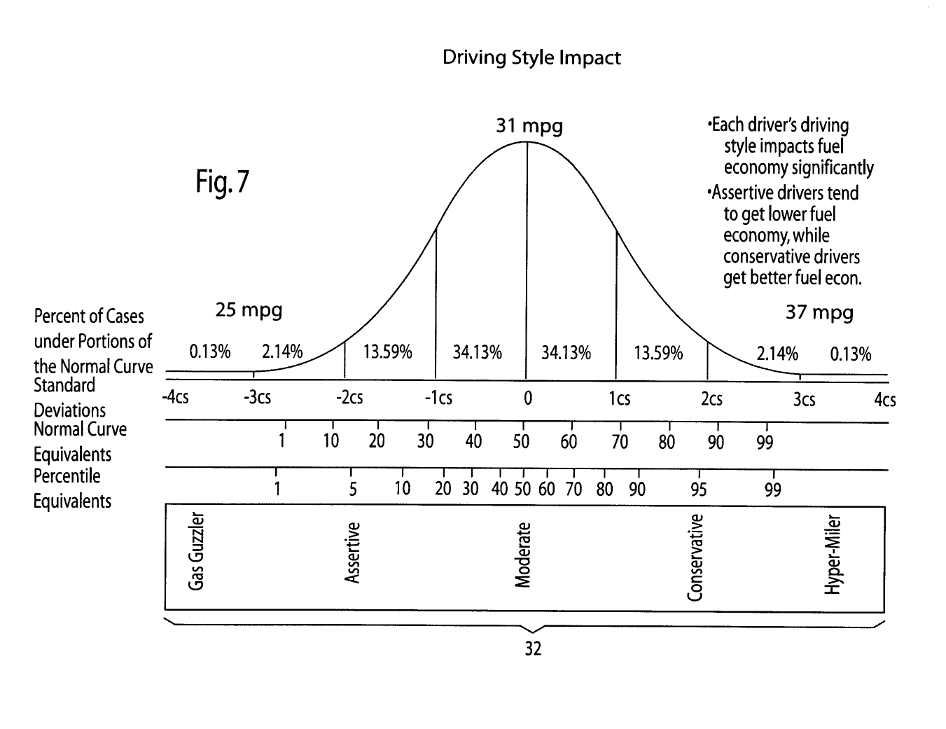

FIG. 7 illustrates utilization of a statistical bell curve to statistically determine a percentage increase or decrease for each of the driver styles 32 available in the driving style pull down menu 54. For example, the table below is an example of the percentage of effect each driving style 32 has on the fuel economy 12. In addition, the system 10 may further speculate and display a trip time for each of the selected vehicles 14, 16 accounting for the user's driving style 32.

TABLE 1
an example of the effect for each driving style

| | Driving style: | | | | |
|---|---|---|---|---|---|
| | | | | | Hyper- |
| | Aggressive | Assertive | Typical | Conservative | miler |
| Fuel | 27.7 | 30.3 | 32.9 | 35.5 | 38.1 |
| economy: | | | | | |
| (miles/ | | | | | |
| gallon) | | | | | |
| Percentage | −15.8% | −7.9% | 0% | 7.9% | 15.8% |
| of change: | | | | | |
| Trip time: | 20.8 | 21.9 | 23 | 24.2 | 25.5 |
| (minutes) | | | | | |
| Percentage | −9.8% | −5% | 0% | 5.3% | 10.8% |
| of change: | | | | | |

FIG. 8 illustrates that the driving style 32 may be incorporated into the driver database 22 and utilized to create the modified route profile 48. The modified route profile 48 is created from the route profile 46 and incorporates the user data 28, specifically the route variables, environmental variables and geographical variables that may have impact on the fuel economy 12 for the selected vehicles 14, 16. Optionally, the system 10 may allow for comparisons between driving style 32, the selected vehicles 14, 16, and the preselected driving route 30. In addition, such comparison would allow for a user 18 to see the effects of driving style 32 on the overall travel time over the preselected driving route 30, as shown in Table 1 above.

The description of the invention is merely exemplary in nature and, plus, variations do not depart from the jest of the invention are intended to be within the scope of the invention. Such variations are not to be regarded as a departure from the spirit and scope of the invention.

What is claimed is:

1. A method of estimating a comparison fuel economy of a particular vehicle applying the steps of:
selecting a plurality of vehicles to compare;
inputting a driving route;
inputting a driving style;
calculating a fuel economy based on the selected vehicle database, the driving route and the driving style; and
displaying the fuel economy for each of the selected vehicles to provide a comparison between the plurality of vehicles.

2. A method as set forth in claim 1 wherein the step of inputting the driving route further includes the step of inputting a time of travel.

3. A method as set forth in claim 2 further includes calculating a route profile based on the driving route and the time of travel.

4. A method as set forth in claim 3 wherein the step of calculating the fuel economy is based on a vehicle database and the route profile.

5. A method as set forth in claim 3 further includes inputting a driver style for calculating a modified route profile.

6. A method as set forth in claim 5 further includes calculating the fuel economy from a vehicle model and the modified route profile.

7. A method of estimating a comparative fuel economy for a selected plurality of vehicles, comprising of a personal computer for displaying a user interface, a network forming a communicative link to a SQL server and the administrative server, the method comprising the steps of:
selecting a first vehicle on the user interface by a user;
selecting a second vehicle on the user interface by the user;
inputting a preselected driving route into the user interface;
calculating a route profile based on the preselected driving route;
inputting a driver style into the user interface by the user;
calculating a modified route profile from the driver style;
submitting the modified route profile for the first vehicle and the second vehicle into the vehicle database to determine a fuel economy for the preselected driving route; and
displaying the fuel economy for each of the selected vehicle for the user to compare the first and second vehicles.

8. A method as set forth in claim 7 wherein the step of inputting a driver style further includes the user inputting route profile modifiers.

9. A system for comparing the fuel economy between a first vehicle and a second vehicle, said system comprising of:
a user interface displayed on a personal computer for receiving inputs from a user, a preselected driving route, a driving style and selecting a first vehicle and a second vehicle;
a SQL server in communication through a network with the user interface for receiving the inputs from the user; and
an administrative server in communication with the SQL server for calculating the fuel economy based on the inputs from the user and displaying a comparison of the fuel economy for the first and second vehicle over the preselected driving route.

10. A system as set forth in claim 9 further includes a mapping software for calculating a route profile for the preselected driving route.

11. A system as set forth in claim 10 further includes a cost model for determining a cost estimation for the first and second vehicle over the preselected driving route.
